(19) United States
(12) Patent Application Publication
(10) Pub. No.: US 2008/0086491 A1
(43) Pub. Date: Apr. 10, 2008

(54) MULTIMEDIA MANAGEMENT AND PLAYBACK APPARATUS

(75) Inventors: Ching-Chieh Wang, Yilan County (TW); Shih-Chung Tu, Taipei County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 11/865,762

(22) Filed: Oct. 2, 2007

Related U.S. Application Data
(60) Provisional application No. 60/828,072, filed on Oct. 4, 2006.

(51) Int. Cl. G06F 3/01; G06F 17/30; G11B 31/00; H04N 5/44

(52) U.S. Cl. 707/101; 348/725; 369/69; 707/102; 715/716; 707/E17.005; 348/E05.096

(57) ABSTRACT

Apparatus for playing and managing multimedia items include a primary storage, a browser and a converter. The converter is used for converting multimedia items from a first item type to a second item type. The browser provides a unified operating interface for accessing multimedia items of both the first item type and the second item type. By dynamically converting the item type of the multimedia items on the primary storage, a better user experience is provided even the capacity of the primary storage is limited.

### CROSS REFERENCE TO RELATED APPLICATIONS

This application claims priority of U.S. Provisional Patent Application Ser. No. 60/828,072, filed Oct. 4, 2006. The contents of the provisional applications are hereby incorporated by reference.

### BACKGROUND

The invention relates to multimedia management and playback apparatus, and more particularly relates to multimedia management and playback apparatus with flexible storage allocation.

This section is intended to introduce the reader to various aspects of the art, which may be related to various aspects of the invention, which are described and/or claimed below. This discussion is believed to be helpful in providing the reader with background information to facilitate a better understanding of the various aspects of the invention. Accordingly, it should be understood that these statements are to be read in this light, and not as admissions of related art.

File storage management is a large and growing problem for a system of multimedia processing, such as a home media center capable of playing and editing broadcast video, audio, image or streamed media. One major storage-related problem in a home media center is file management. Generally, media files are distributed among various DVDs or other storage media. As the number of DVD/CDR discs increases, file management becomes complicated.

### SUMMARY

Certain aspects commensurate in scope with the originally claimed invention are set forth below. It should be understood that these aspects are presented merely to provide the reader with a brief summary of certain forms the invention might take and that these aspects are not intended to limit the scope of the invention.

An embodiment according to the invention is a multimedia management and playback apparatus that is capable of saving memory storage. The multimedia management and playback apparatus includes a primary storage, a browser and a coverter. The primary storage is used for storing multimedia items of a first item type and a second item type, wherein each multimedia media item of the first item type contains full multimedia information and each multimedia item of the second item type contains only a portion of multimedia information. The browser is used for providing a user an interface to browse the multimedia items of both the first item type and the second item type. The converter for converting the multimedia items of the first item type into the second item type. With such design, even the primary storage has limited capacity, a more unified and convenient interface is possible to provide users better experience on using such apparatus.

### BRIEF DESCRIPTION OF DRAWINGS

The invention can be more fully understood by reading the subsequent detailed description and examples with references made to the accompanying drawings, wherein:

FIG. 1 is a schematic view of an embodiment of a data processing system;

FIGS. 2A-2C are flowcharts of embodiments of a data processing method;

FIG. 3 is a flowchart of an embodiment of a data processing method;

FIG. 4 illustrates a medium processing system;

FIG. 5 is a flowchart of an embodiment of a data processing method;

FIG. 6 is an exemplary display screen of the method of FIG. 5;

FIG. 7 is an exemplary display screen of the method of FIG. 5; and

FIG. 8 illustrates another embodiment of a data processing system.

### DETAILED DESCRIPTION

One or more specific embodiments of the invention are described below. In an effort to provide a concise description of these embodiments, not all features of an actual implementation are described in the specification. It should be appreciated that in the development of any such actual implementation, as in any engineering or design project, numerous implementation-specific decisions must be made to achieve developer specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

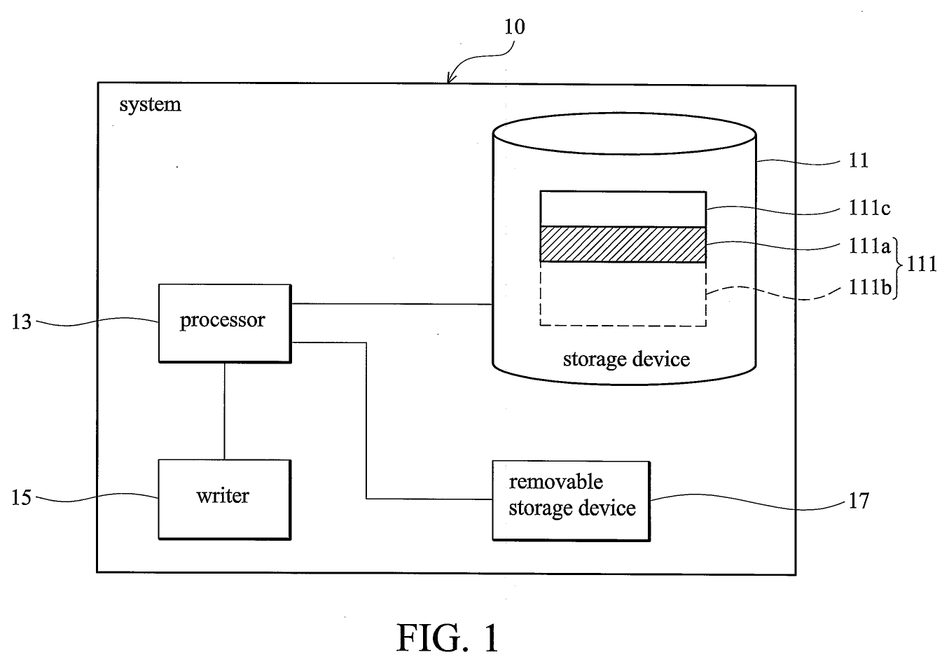

The invention is now described with reference to FIGS. 1 through 8, which generally relate to managing multimedia items. A multimedia item may refer to one or more files or directories that store multimedia information. In the following detailed description, reference is made to the accompanying drawings which form a part hereof, shown by way of illustration of specific embodiments. These embodiments are described in sufficient detail to enable those skilled in the art to practice the invention, and it is to be understood that other embodiments may be utilized and that structural, logical and electrical changes may be made without departing from the spirit and scope of the present invention. The following detailed description is, therefore, not to be taken in a limiting sense. The leading digit(s) of reference numbers appearing in the figures correspond to the Figure number, with the exception that the same reference number is used throughout to refer to an identical component which appears in multiple figures. It should be understood that many of the elements described and illustrated throughout the specification are functional in nature and may be embodied in one or more physical entities or may take other forms beyond those described or depicted.

FIG. 1 is a schematic view of an embodiment of a data processing system. Examples of such a data processing system include an electronic apparatus for multimedia management and playback apparatus, e.g. a DVD player, a Blue-Ray player/recorder, etc. Such data processing system can be connected to one or more external devices like display screens, input devices, remote controls, etc. With these external devices connected via wireless and/or wire links, such data processing system render multimedia information, like videos, still images, text files and/or music audios. Alternatively, such data processing system may have its own display, speaker and/or input devices. In this simplified example, a system 10 comprises a storage device 11, a processor 13, and a writer 15.

Storage device 11 stores a file 111, one common type of multimedia items. A multimedia item referred here may indicate any type of entity for storing multimedia information. In other case, a multimedia item may include more than one file and/or associated directory structure. Alternatively, a multimedia item may be an entry in a database, stored in compressed or encrypted format. The storage device 11 can be a hard disk of system 10. Originally, file 111 comprises file content 111b and metadata 111a.

In order to alleviate storage load, file 111 can be virtualized, e.g., at least part of file content 111b is removed from file 111. If file 111 contains full multimedia information, such file 111, as a multimedia item, may be classified as a first item type. When a portion of the file content 111b is removed from file 111, the file 111 may be classified as a second item type, which means such multimedia item contains only a portion of multimedia information instead of complete multimedia information. The virtualization is performed by processor 13 for performing conversion from first item type into second item type. In this example, processor 13 generates an extract 111c from the file content 111b, stores the extract 111c associated with the metadata 111a, and removes the file content 111b from the first file, thus alleviating the storage load of storage device. In another example, the extract 111c may also be generated from the metadata 111a. Alternatively, the extract 111c may also be generated from both the metadata 111a and the file content 111b. For example, file 111 is a video file. During virtualization or so-called conversion, one or more video pictures from the full video file are extracted and a new header of the video file is updated. In another example, file 111 is an image file. During virtualization or conversion, the original image is scaled down to another image of lower resolution, e.g. a thumb image. In yet another example, file 111 is an audio file. During virtualization or conversion, metadata like singer names or certain audio clips are extracted while other information is removed from the file 111. The removed file content 111b can be stored in another storage device, which is called secondary storage here, such as a removable storage device 17. The removable storage device 17 can be a disc or other removable storage media or a network storage, e.g. some space in a network server. The virtualized file can be restored by copying the file content 111b or other previously removed data from removable storage device 17. That is, a multimedia item of the second item type is converted into an associated multimedia item of the first type. The processor 13, together with necessary software and/or hardware, provides a browser to provide an interface for a user to browse the multimedia items of both the first item type and the second item type. For example, the browser renders and outputs corresponding interactive images on a connected display to show a menu, on which a user can view both video files containing full video, i.e. the first item type and video files containing only a portion of video contents, i.e. the second item type. The user can also organize these multimedia items, e.g. to arrange them in different ways or instruct the processor 13 to perform conversion on particular multimedia items, e.g. to convert a video file of full video contents into a video file of a portion of video contents and to store full video contents in a secondary storage like a optical disc or a network storage. In addition, the user can use the browser to play appointed multimedia items. If the appointed multimedia item is of the first item type, the system 10 starts playing the contents of the appointed multimedia item. Otherwise, the system 10 retrieves full multimedia contents from corresponding secondary storage so as to convert the multimedia item of the second item type into an associated multimedia item of the first item type and then plays the multimedia item type.

Since there can be more than one secondary storage for storing full multimedia information, a manager, which refers to software and/or hardware and/or their combination running over the system 10, is prepared. The manager assigns an identifier for each optical disc. The identifier can be stored within a corresponding multimedia item of the second item type. With such, when the user appoints a multimedia item of the second item type via the browser as mentioned above, the browser shows the identifier and the user knows which optical disc contains full multimedia information. Moreover, there are printers that can print human readable images on optical discs, like CDR, DVD, Blue-Ray. A marker, e.g. a mini printer and corresponding software, hardware and/or their combination, can be embedded in the system 10 so as to print identifiers on optical discs to provide a even more convenient apparatus for users. Alternatively, if the appointed multimedia item is of the second item type, the appointed multimedia item may also be played directly from the secondary, instead of converting the appointed multimedia item from the second item type into the first item type.

If a secondary storage is a network storage, an address, e.g. an URL, can be stored within a corresponding multimedia item of the second item type.

Besides, the storage 11, herein referred as an example of a primary storage, can refer to one or more than one hard disks or other types of storage. Even the capacity of a hard disk today can reach to 500 GB or 1 TB, users are never satisfied. For example, if the primary storage is 500 GB, and each DVD movie takes 5 GB, the primary storage can only store 100 movies. When the system 10 is used for recording TV programs, storage capacity requirement even increases. Therefore, a resource adjuster, which can be software, hardware and/or their combination, is designed to detect the usage of the primary storage. Once the primary storage reaches a predetermined level, the resource adjuster can be configured to instruct the converter mentioned above to perform conversion for converting certain amount of multimedia items of the first item type into the second item type and storing full multimedia information in one or more secondary storages.

When storing the file 111 in the removable storage device 17, the processor 13 assigns the removable storage device 17 an identification number or any other identification. The writer 15 can write an identification number or any other identification in removable storage device 17 or on a surface thereof using a machine-readable format. When the removable storage device 17 is inserted in system 10, the identification number or any other identification thereof can be recognized. The writer 15 can also write the identification number or any other identification on a surface of removable storage device 17 using a human-readable format for easy recognition of the identification number.

If file 111 is stored in removable storage device 17, processor 13 further generates a pointer to the metadata 111a, wherein the pointer comprises the identification number or any other identification of removable storage device 17. When the virtualized file 111 is accessed, complete file 111 comprising file contents 111b can be located by referencing the pointer.

When a new file is to be input to storage device 11, processor 13 further determines whether the storage device 11 has sufficient capacity for the file, and if so, the file is stored in the storage device 11, otherwise, the file can be virtualized using the described method, and the virtualized file can be stored in storage device 11.

The file 111 can be virtualized in situ. In addition, the virtualized file, comprising metadata 111a and extract 111c, can be stored in a new position of storage device 11 other than its original storage position. In yet another example, file 111 is an audio file. During virtualization or conversion, metadata like singer names or certain audio clips are extracted while other information is removed from the file 111. A plurality of virtualized files can be organized as a virtual directory. The virtual directory comprises a file name hierarchy, wherein the file name hierarchy comprises a virtual path name of each virtualized file.

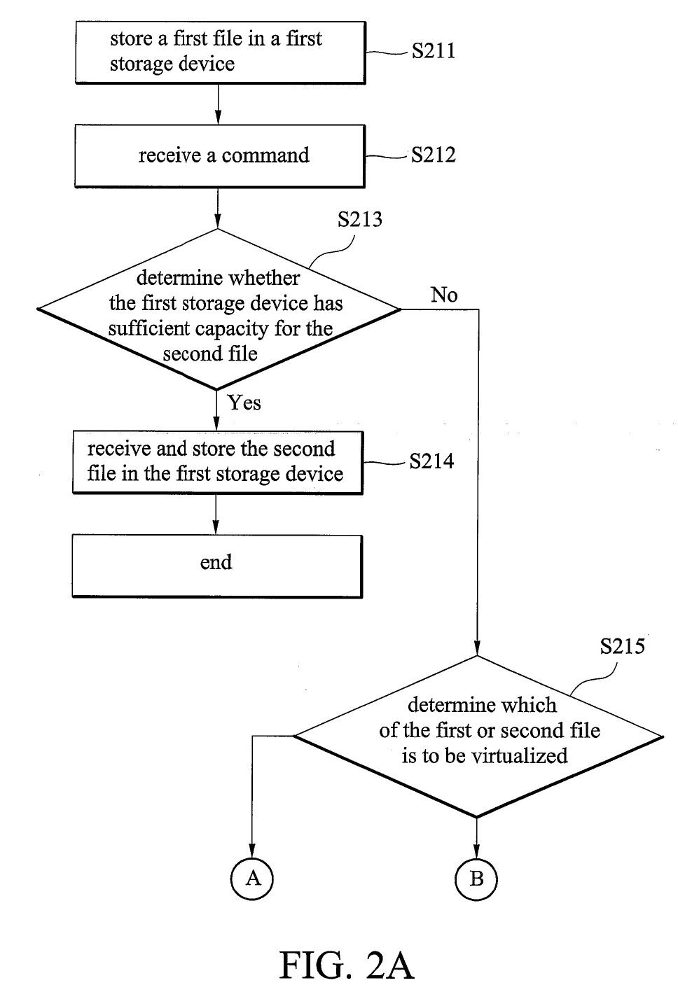

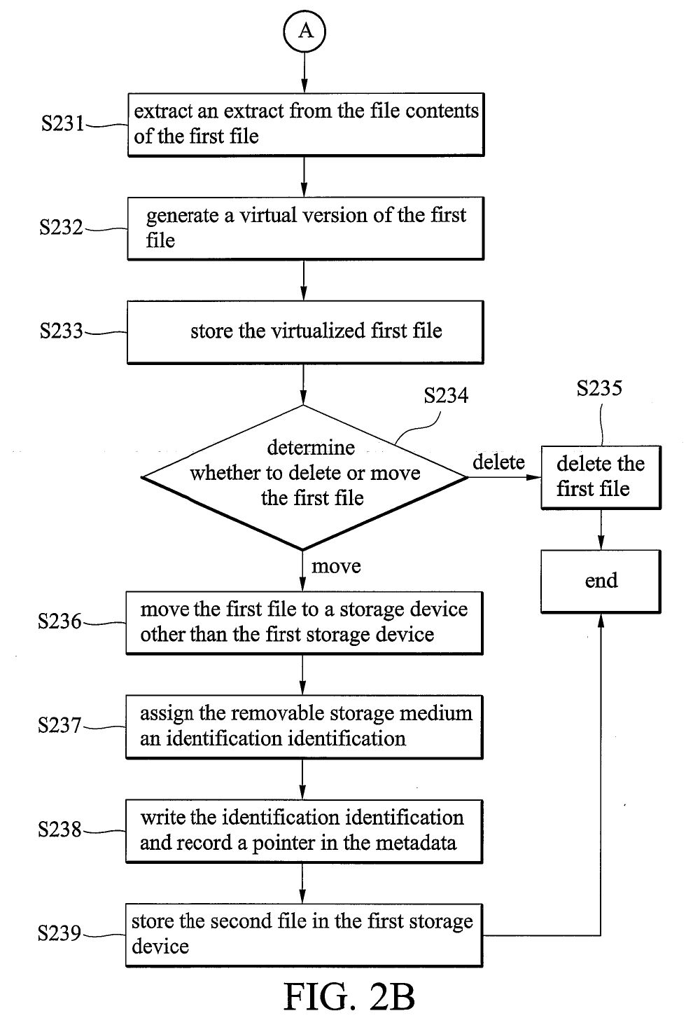

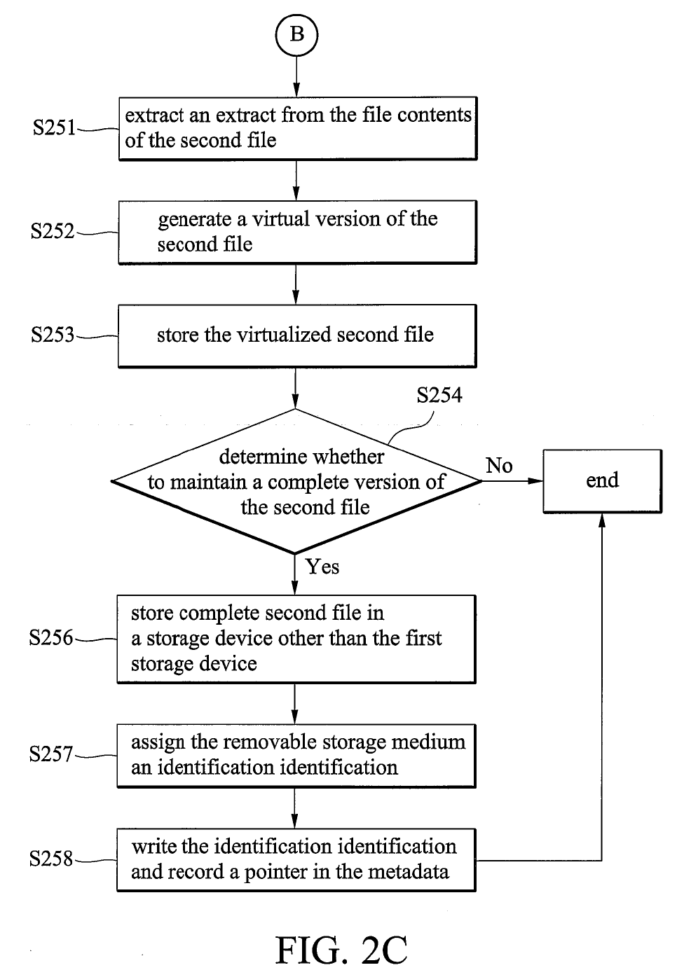

FIGS. 2A-2C are flowcharts of embodiments of a data processing method. The method of FIGS. 2A-2C can be implemented in the system of FIG. 1. Here, a new file is to be added into a storage device and/or a backup of a file originally stored in the storage device is to be generated.

In step S211, a first file is stored in a first storage device, wherein the first file comprises file contents and metadata. Here, the first storage device can be storage device 11 of FIG. 1. In step S212, a command is received, directing a second file to be stored in the first storage device. The second file comprises file contents and metadata. In step S213, it is determined whether the first storage device has sufficient capacity for the second file, and if so, the method proceeds to step S214, otherwise, to step S215. Alternatively, a capacity threshold may be set and the capacity threshold is used for determining whether to store the second file directly. In step S214, the second file is received and stored in the first storage device, and the method ends. If the capacity is insufficient or adding the second file exceeds the capacity threshold, the first or second file can be virtualized to alleviate the storage load of the first storage device. In step S215, it is determined whether the first or second file is to be virtualized. If the first file is to be virtualized, the method proceeds to procedure A, if the second file is to be virtualized, the method proceeds to procedure B. The target of virtualization, i.e., the first file or the second file, can be determined according to preset rules to meet requirements. For example, the target of virtualization can be selected by access frequency. Alternatively, to add the second file into the first storage device may need to virtualize more than one file. The following virtualization only serves as an example, instead of limitation to the scope of the invention.

Referring to FIG. 2B, the first file, originally stored in the first storage device, is virtualized. The first file comprises file contents and metadata. An extract is extracted from the file contents of the first file (step S231). Alternatively, the extract may also be extracted from the metadata or from both the metadata and the file contents. A virtual version of the first file (hereinafter referred to as a virtualized first file) is generated from the extract and the metadata (step S232). The virtualized first file is stored (step S233). The first file can be virtualized in situ, wherein the path name of the virtualized first file is the same with the first file. In addition, the virtualized first file, comprising the metadata and extract of the first file, can be situated in a virtual directory. A plurality of virtualized files can be organized as the virtual directory. The virtual directory comprises a file name hierarchy, wherein the file name hierarchy comprises a virtual path name of the first virtualized file and other virtualized files. In step S234, it is determined whether the first file is to be moved or deleted. If the first file is to be deleted, the method proceeds to step S235. In step S235, the first file is deleted, and the method ends. If the first file is to be moved, the method proceeds to step S236. In step S236, the first file is moved to a storage device other than the first storage device, such as removable storage medium (for example a disc). In step S237, the removable storage medium is assigned an identification number or other identification. In step S238, the identification number or other identification is written in the removable storage device or on a surface thereon, and a pointer specifying the identification number of the removable storage device is recorded in the metadata. In step S239, the second file is stored in the first storage device, and the method ends. Please be noted that the writer is optional but not necessary.

Referring to FIG. 2C, the second file is virtualized. The second file comprises file contents and metadata. An extract is extracted from the file contents of the second file (step S251). A virtual version of the second file (hereinafter referred to as a virtualized second file) is generated from the extract and the metadata thereof (step S252). The virtualized second file is stored (step S253). The virtualized second file, comprising the metadata and extract of the second file, can be situated in a virtual directory. A plurality of virtualized files can be organized as the virtual directory. The virtual directory comprises a file name hierarchy, wherein the file name hierarchy comprises a virtual path name of the second virtualized file and other virtualized files. In step S254, it is determined whether a complete version of the second file is to be maintained, and if so, the method proceeds to step S256, otherwise, the method ends. In step S256, a complete version of the second file is stored to a storage device other than the first storage device, such as a removable storage medium (for example a disc). In step S257, the removable storage medium is assigned an identification number or other identification. In step S258, the identification number or other identification is written in the removable storage device or on a surface thereof, and a pointer specifying the identification number of the removable storage device is recorded in the metadata.

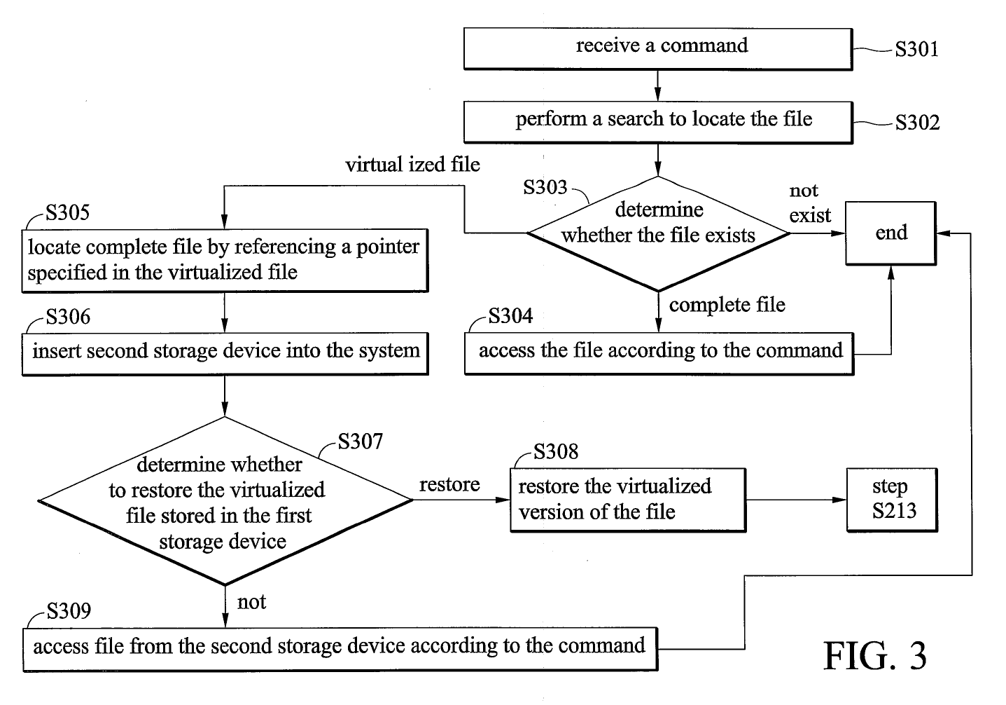

FIG. 3 is a flowchart of an embodiment of a data processing method, which serves an example and not a limitation to the scope of the invention. The method of FIG. 3 can be implemented in the system of FIG. 1. Here, a file is to be accessed.

In step S301, a command is received, directing a file to be accessed. In step S302, a search is performed to locate the file. In step S303, it is determined whether the file exists. If the file does not exist, the method ends. If a virtualized version of the file exists, the method proceeds to step S305, if a complete version of the file exists, the method proceeds to step S304. In step S304, the file is accessed according to the command. When a virtualized version of the file is stored in the first storage device, a complete version of the file can be located by referencing a pointer specified in the virtualized file (step S305). The pointer comprises an identification number of a second storage device of the file. The second storage device, such as a disc, can be inserted into the system for access the file (step S306). In step S307, it is determined whether the virtualized file stored in the first storage device is to be restored. If the virtualized file stored in the first storage device is to be restored, the complete version of the file is retrieved from the second storage device, and the complete contents of the file are added to the virtualized version of the file (step S308). When the file is to be restored, the method proceeds to step S213 in FIG. 2A, for virtualization of file. If the virtualized file stored in the first storage device is not to be restored, the complete version of the file is simply accessed from the second storage device according to the command (step S309).

Here, two embodiments of a data processing system are provided.

### First Embodiment

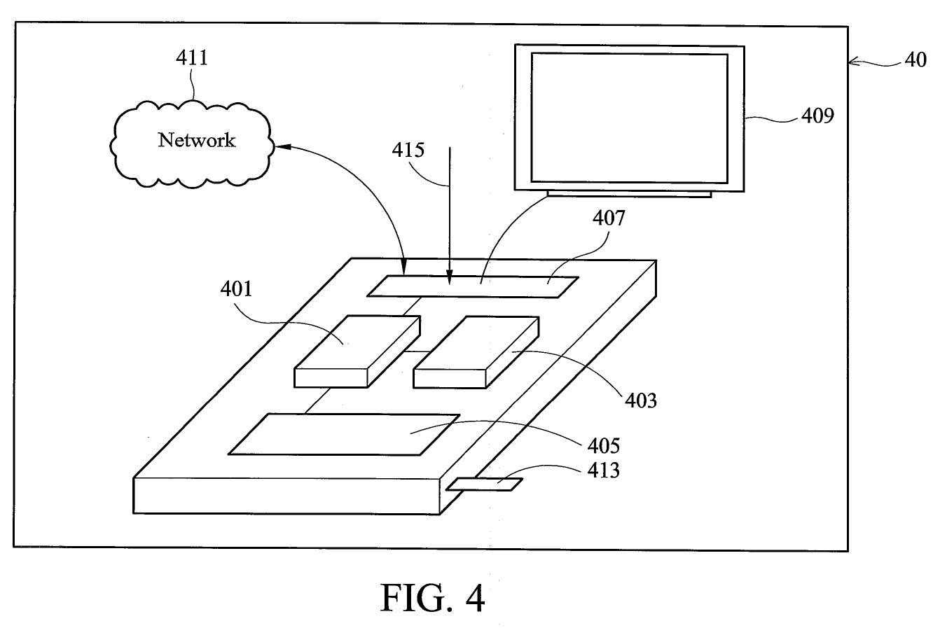

FIG. 4 illustrates a medium processing system 40, comprising a processor 401, a primary storage device 403, a secondary storage device 405, and an interface 407. A display 409 connects to medium processing system 40 via interface 407. The medium processing system 40 receives signals 415 via interface 407. In addition, a network 411 and other peripheral devices, e.g. a tuner (not shown) connect to the medium processing system 40 via interface 407.

The primary storage device 403 can be a hard disk with a limited storage capacity, such as, 500 Gigabytes. The secondary storage device 405 can be a DVD player reading and writing data from and to a DVD disc. The secondary storage device 405 can be a remote storage location on the Internet connected to the medium processing system 40 via the network 411, a flash storage device 413 connected to the medium processing system 40, or other suitable storage device. The display 409 can be a television set or a monitor presenting information and/or media data. The signals 415 can be television signals or other data streams/files received by medium processing system 40 via the interface 407.

The processor 401 can comprise one or more general purpose PC compatible chips, or one or more dedicated processing chips with associated components that can decode, edit, and/or control access to the primary storage device 403, the secondary storage device 405, and dataflow via interface 407.

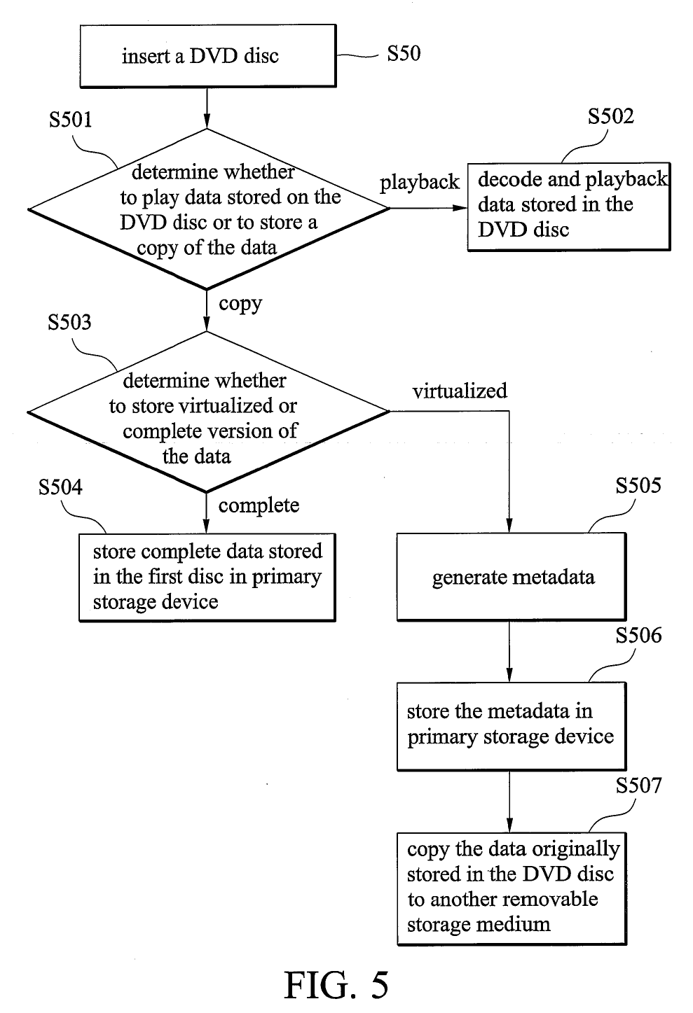

FIG. 5 is a flowchart of an embodiment of a data processing method. The method of FIG. 5 can be implemented by an operating system or a software application. In addition, the method of FIG. 5 can be implemented by circuit logic.

In step S50, a DVD disc (hereinafter referred to as a first disc) is inserted into medium processing system 40. In step S501, it is determined whether to play data stored on the DVD disc or to store of copy of the data in the medium processing system 40. If a playback operation is required to process the data stored in the DVD disc, the method proceeds to step S502, otherwise, to step S503. In step S502, data stored in the DVD disc is decoded and displayed on the display 409. In step S503, it is determined whether to store a virtualized version or a complete version of the data originally stored on the DVD disc. If a virtualized version is to be stored, the method proceeds to step S505, otherwise, to step S504.

The determination step S503 can be implemented according to a preset rule. For example, the preset rule specifies a limitation of current usage and available capacity of primary storage device 403. If the available capacity of primary storage device 403 is less than 30% of a total capacity thereof, a virtualized version of the data is generated and stored in primary storage device 403.

In step S504, a complete version of the data stored in the first disc is stored in primary storage device 403.

In step S505, metadata is generated. In step S506, the metadata is stored in primary storage device 403. In addition, the data originally stored in the DVD disc can be copied to another removable storage medium, for example, another DVD disc (step S507). In this case, a blank DVD disc (hereinafter referred to as a second disc) is inserted into medium processing system 40 for storing a copy of the duplicated data. In addition, a serial number may be assigned and stored as a component of the metadata. The serial number may be specified on the second disc as a printed label.

The metadata for a video file may comprise video stream samples, text, video file name, subtitles, and/or other information enabling a preview and/or a search operation. The metadata of an audio file may comprise audio clips, author information, file size, and/or file duration.

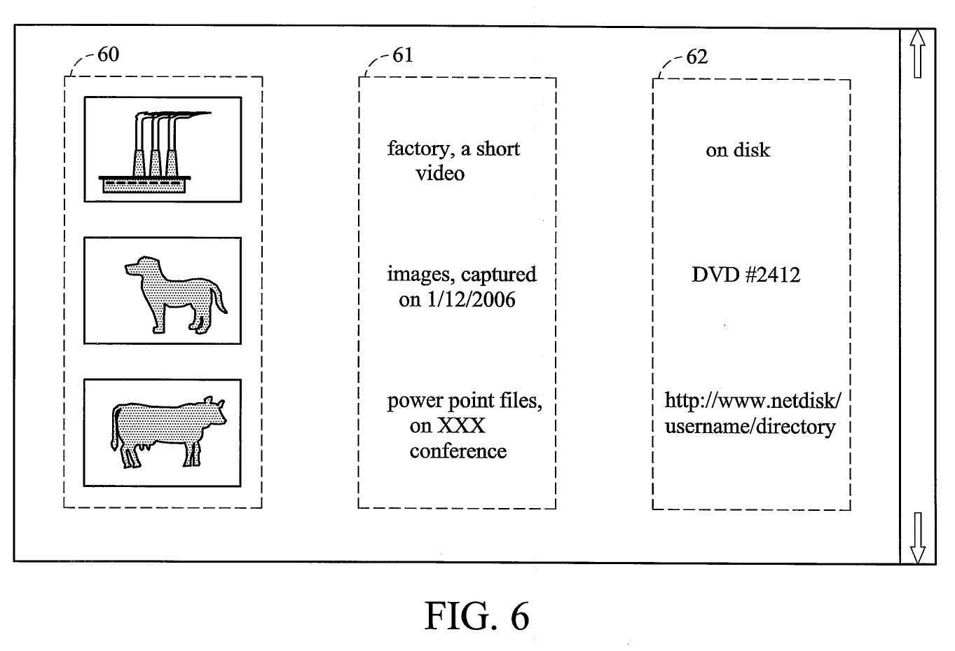

FIG. 6 is an exemplary display screen displayed in the method of FIG. 5. In FIG. 6, each file is associated with an introductory description 61, an image clip 60, and a storage location pointer 62. The introductory description 61, image clip 60, and storage location pointer 62 can be used to manage media files stored in primary storage device 403 or other storage media. For example, for a file stored in a DVD disc, a serial number assigned to the DVD disc is provided to facilitate location of the file.

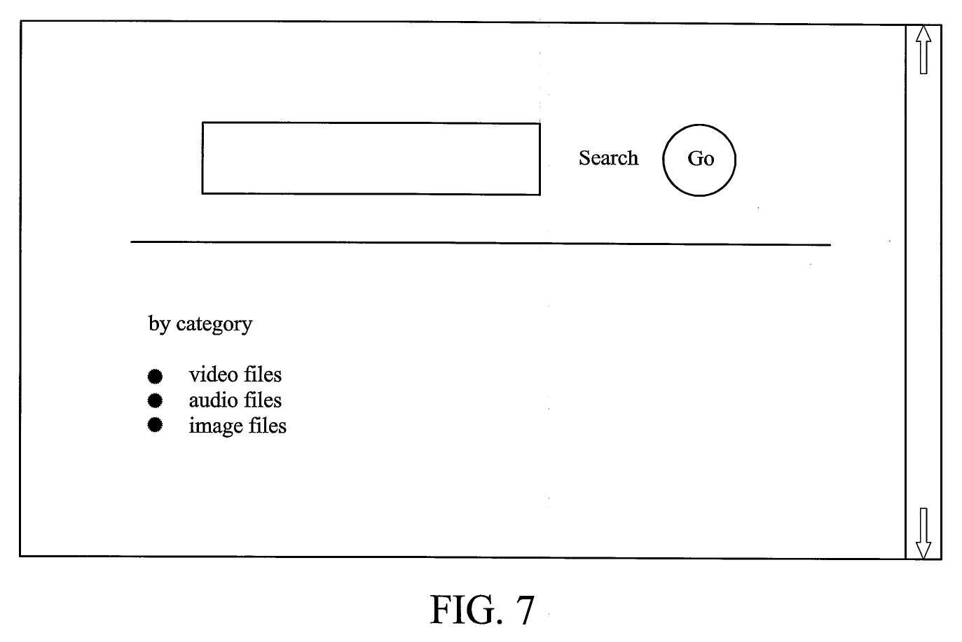

FIG. 7 is an exemplary display screen displayed in the method of FIG. 5. In FIG. 7, a file can be searched by category.

The preset rule used in step S503 varies to meet requirements.

407 for frequently accessed files, a complete version thereof is stored in primary storage device 403; a virtualized version of a less-accessed file, can be stored in primary storage device 403, and a complete version thereof can be stored in a removable storage medium, such as a disc.

For example, a preset rule can specify that a large virtualized version of a file can be stored in primary storage device 403, and a complete version thereof can be stored in a removable storage medium, such as a disc.

The determination of step S503 can be performed manually by a user. In this case, interface 407 requires a user to indicate whether a complete or a virtualized version of the data is to be stored, and a storage location for the copy is required as well.

### Second Embodiment

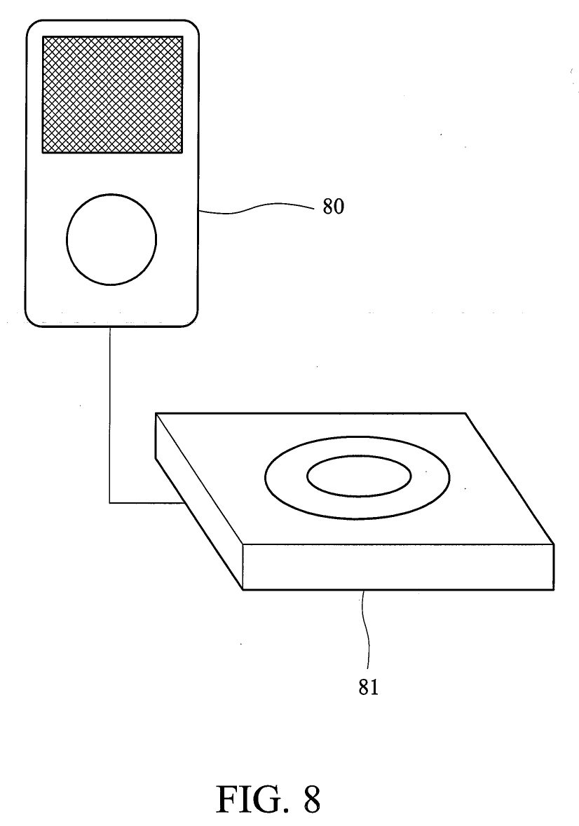

FIG. 8 illustrates another embodiment of a data processing system. A portable electronic device 80, such as an iPOD, is implemented with a DVD recorder/player 81.

One frequently used function of an iPOD is music playback. Conventionally, an iPOD receives music files from a computer via download from a network storage location. In this embodiment, an iPOD can store a complete version or a virtualized version of a music file. The virtualized file can comprise an extract of the file contents and other information related to the file. The virtualized file occupies little storage space. The virtualized file can be restored to its complete version by receiving corresponding contents from DVD recorder/player 81 or a storage location on network. When new contents are input into the iPOD, methods of FIGS. 2A-2C and 3 can be implemented.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A multimedia management and playback apparatus, comprising:
a primary storage for storing multimedia items of a first item type and a second item type, wherein each multimedia item of the first item type contains full multimedia information and each multimedia item of the second item type contains only a portion of multimedia information;
a browser for providing a user an interface to browse the multimedia items of both the first item type and the second item type; and
a converter for converting the multimedia items of the first item type into the second item type.

2. The multimedia management and playback apparatus of claim 1, wherein the converter further converts multimedia items of the second item type into the first item type

3. The multimedia management and playback apparatus of claim 2, wherein corresponding full multimedia information of each multimedia item of the second item type is stored in a secondary storage.

4. The multimedia management and playback apparatus of claim 3, wherein the converter converts the multimedia items of the first item type into corresponding multimedia items of the second item type by replacing the multimedia items of the first item type with the corresponding multimedia items of the second item type that contain only the portion of multimedia information in the primary storage and storing the full multimedia information in the second storage.

5. The multimedia management and playback apparatus of claim 4, the converter converts the multimedia items of the second item type into corresponding multimedia items of the first item type by replacing the multimedia items of the second item type with corresponding multimedia items of the first item type in the primary storage, corresponding full multimedia information being retrieved from the secondary storage when constructing the corresponding multimedia items of the first item type in the primary storage.

6. The multimedia management and playback apparatus of claim 3, wherein the second storage is a network storage.

7. The multimedia management and playback apparatus of claim 6, wherein the multimedia item of the second item type contains an address for locating corresponding full multimedia information stored in the second storage.

8. The multimedia management and playback apparatus of claim 3, wherein the second storage is an optical disc.

9. The multimedia management and playback apparatus of claim 8, further comprising:
a manager for assigning an identifier corresponding to each optical disc, wherein the identifier is stored in corresponding multimedia item of the second item type.

10. The multimedia management and playback apparatus of claim 9, further comprising:
a writer for marking the identifier on corresponding optical disc.

11. The multimedia management and playback apparatus of claim 9, wherein the browser indicates the identifier to the user so that the user marks the identifier on the optical disc by reference to the identifier.

12. The multimedia management and playback apparatus of claim 9, wherein the browser indicates the identifier to the user so that the user knows which optical disc contains corresponding full multimedia information for the converter to convert one multimedia item of the second item type into one corresponding multimedia item of the first item type.

13. The multimedia management and playback apparatus of claim 3, further comprising:
a resource adjuster for instructing the converter to perform conversion between the multimedia items of the first item type and the multimedia items of the second item type.

14. The multimedia management and playback apparatus of claim 13, wherein the resource adjuster detects usage ratio of the primary storage so as to determine when to instruct the converter to perform conversion between the multimedia items of the first item type and the multimedia items of the second item type.

15. The multimedia management and playback apparatus of claim 13, wherein the resource adjuster instructs the user via the browser to inform current capacity of the primary storage so that the user decides when to convert multimedia items of the first item type into the multimedia items of the second item type.

16. The multimedia management and playback apparatus of claim 13, further comprising:
a television tuner for receiving television streams into the multimedia items of the first item type.

17. The multimedia management and playback apparatus of claim 3, wherein the user organizes the multimedia items via the browser.

18. The multimedia management and playback apparatus of claim 3, wherein the multimedia management and playback apparatus is a DVD player.

19. A multimedia management and playback apparatus, comprising:
a primary storage for storing multimedia items of a first item type and a second item type, wherein each multimedia media item of the first item type contains full multimedia information and each multimedia item of the second item type contains only a portion of multimedia information;
a converter for converting the multimedia items of the first item type into the second item type and for converting multimedia items of the second item type into the first item type; and
a resource adjuster for instructing the converter to perform conversion between the multimedia items of the first item type and the multimedia items of the second item type.

20. A data processing method, comprising:
providing a first file in a first storage device, wherein the first file comprises file contents and metadata;
generating an extract from the file contents, the metadata or from both the file contents and the metadata of the first file;
storing the extract; and
moving the first file or the file contents to a secondary storage.
